(19) United States
(12) Patent Application Publication
(10) Pub. No.: US 2017/0297805 A1
(43) Pub. Date: Oct. 19, 2017

(54) HEAT INSULATING CONTAINER

(71) Applicants: THERMOS L.L.C., Schaumburg, IL (US); THERMOS K.K., Tsubame-shi (JP)

(72) Inventors: Hiroyuki Yaguchi, Tsubame-shi (JP); Shin Matsuyama, Tsubame-shi (JP)

(21) Appl. No.: 15/484,742

(22) Filed: Apr. 11, 2017

(30) Foreign Application Priority Data
Apr. 13, 2016 (JP) 2016-080153

(51) Int. Cl. B65D 81/38; A23G 9/22; A47J 39/00; B65D 41/02

(52) U.S. Cl. CPC B65D 81/3844; B65D 41/02; A23G 9/22; A47J 39/00

(57) ABSTRACT

A heat insulating container is described which can keep a heat insulating state (including cold insulating state) of an inside container stored in an outside container for a long period of time, and improve safety and usability. The heat insulating container may include the outside container having a heat insulating structure; the inside container having a cold insulating structure or a heat insulating structure; and a cover member which is attached to the inside container in a state in which the inside container is stored in the cover member; in which the inside container is stored in the outside container in a non-contact state through the cover member.

### CROSS REFERENCE TO RELATED APPLICATION

This application claims priority to Japanese Patent Application 2016-080153 filed Apr. 13, 2016, which is hereby incorporated by reference.

### Field of Invention

The present invention relates to a heat insulating container.

### Background

In the related art, there are heat insulating containers which keep contents stored in an inside container warm by putting the inside container into an outside container having a vacuum heat insulating structure.

Specifically, there is a heat insulating container including an outside container which is a heat insulating container, and an inside container, which includes an inner cylindrical member and an outer cylindrical member and a heat insulating material which insulates heat by microwave between the inner cylindrical member and the outer cylindrical member, is put in the outside container in a detachable manner.

In addition, there is a heat insulating cooker (heat insulating container) including an outside container having heat insulating properties, an inside container which is put in the outside container in a freely taking-in/out manner, and a lid member having heat insulating properties which closes an opening of the outside container while storing the inside container in the outside container.

In addition, there are cold insulating containers which keep contents stored in an inside container cold by putting an inside container which is cold by a cold insulating agent in an outside container having a vacuum heat insulating structure.

Such a cold insulating container is used as an ice cream maker for household use, for example. In the ice cream maker, the inside container can be maintained cold for a long period of time by putting the inside container, which is cold at a freezing point (0° C.) or less in a freezer, in the outside container having a vacuum heat insulating structure. After pouring a raw liquid of ice cream into the inside container, and stirring the raw liquid of ice cream, ice cream can be easily made.

However, in the ice cream maker explained above, when the inside container is taken out from a freezer, it is necessary to put the cold inside container in the outside container using mittens not to frostbitten without having direct contact with the cold inside container. It is also possible to form a handle to the inside container to prevent direct contact. However, when the handle is formed to the inside container, excessive space for the handle is necessary in a freezer, and it is inconvenient.

In addition, since heat of the outside container is transmitted to the inside container by putting the inside container in the outside container, it is difficult to maintain the inside container cold for a long period of time. Accordingly, it is preferable that the inside container be not in contact with the outside container.

### SUMMARY

An object of embodiments of the invention is to provide a heat insulating container which can keep the inside container stored in the outside container warm (including cold) for a long period of time, and improve safety and usability.

A first embodiment may include a heat insulating container including: an outside container having a heat insulating structure; an inside container having a cold insulating structure or a heat insulating structure; and a ring member which is fitted to an outer periphery of an upper end of the inside container; in which the inside container is stored in the outside container in a non-contact state through the ring member.

In a second embodiment of the heat insulating container according to the first embodiment described above, a lower step portion is formed on an outer periphery of the ring member, and the inside container is stored in the outside container in a state in which an upper end of the outside container is in contact with the lower step portion.

In a third embodiment of the heat insulating container according to the first or second embodiment described above, the ring member is made of an elastic material, and the ring member is attached to the inside container in a detachable manner.

In the fourth embodiment of the heat insulating container according to any one of the first to third embodiments described above, the heat insulating container further includes a cap member which closes an upper opening portion of the inside container, and the upper opening portion of the inside container is closed with the cap member in a non-contact manner through the ring member.

In the fifth embodiment of the heat insulating container according to the fourth embodiment described above, the ring member includes an upper step portion on an outer periphery thereof, and the upper opening portion of the inside container is closed with the cap member in a state in which a lower end of the cap member is in contact with the upper step portion.

In the sixth embodiment of the heat insulating container according to any one of the first to fifth embodiments described above, the heat insulating container further includes a cover member which is attached to the inside container in a state in which the inside container is stored in the cover member.

In the seventh embodiment of the heat insulating container according to the sixth embodiment described above, an engagement recess portion is formed on one of an outer periphery of the inside container or an inner periphery of the cover member, an engagement convex portion is formed on the other of an outer periphery of the inside container or an inner periphery of the cover member, and the cover member is attached to the inside container in a detachable manner by engaging the engagement recess portion and the engagement convex portion.

In the eight embodiment of the heat insulating container according to the sixth or seventh embodiment described above, a slit which is cut from an upper end of the cover member in a depth direction is formed in the cover member.

The ninth embodiment may include a heat insulating container includes: an outside container having a heat insulating structure; an inside container having a cold insulating structure or a heat insulating structure; and a cover member which is attached to the inside container in a state in which the inside container is stored in the cover member; in which the inside container is stored in the outside container in a non-contact state through the cover member.

In the tenth embodiment of the heat insulating container according to the ninth embodiment described above, the heat insulating container further includes a ring member on an outer periphery of an upper end of the inside container.

In the eleventh embodiment of the heat insulating container according to any one of the first to tenth embodiments described above, the inside container is made of metal.

In the above-mentioned manner according to the present invention, it is possible to provide a heat insulating container which can keep the heat insulating state (including cold insulating state) of inside container stored in the outside container for a long period of time, and improve safety and usability.

### BRIEF DESCRIPTION OF DRAWINGS

FIG. 1 is a perspective view that shows an embodiment of an ice cream maker.

FIG. 2 is an exploded perspective view that shows the ice cream maker shown in FIG. 1.

FIG. 3 is an exploded perspective view that shows the inside container shown in FIG. 2.

FIG. 4 is a cross-sectional view that shows a main part of the cream maker shown in FIG. 1.

### DETAILED DESCRIPTION OF INVENTION

In this section, embodiments of the invention will be described in detail with reference to the drawings. However, the scope of the invention is not limited by the exact embodiments illustrated. Elements that have a similar or the same function (as known by a person having ordinary skill in the art) as those described are within the scope of this application.

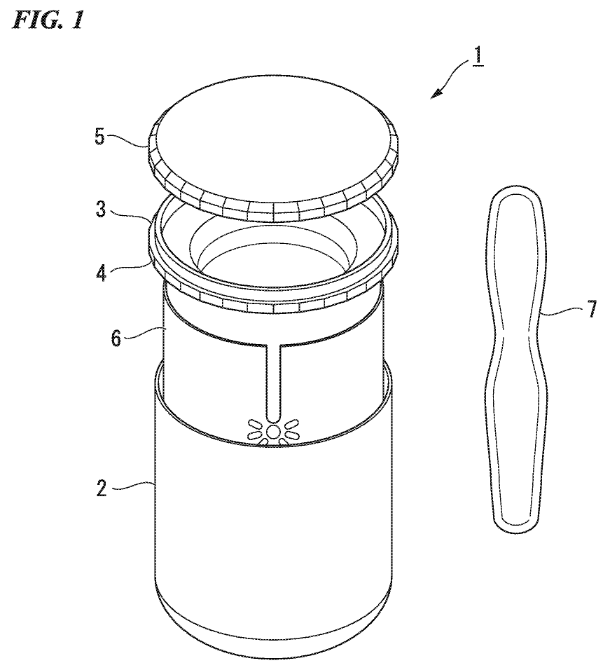

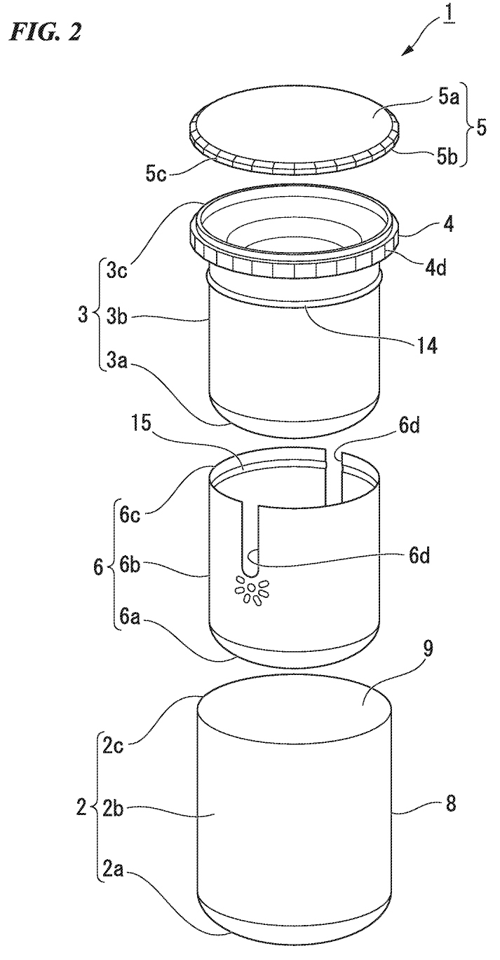

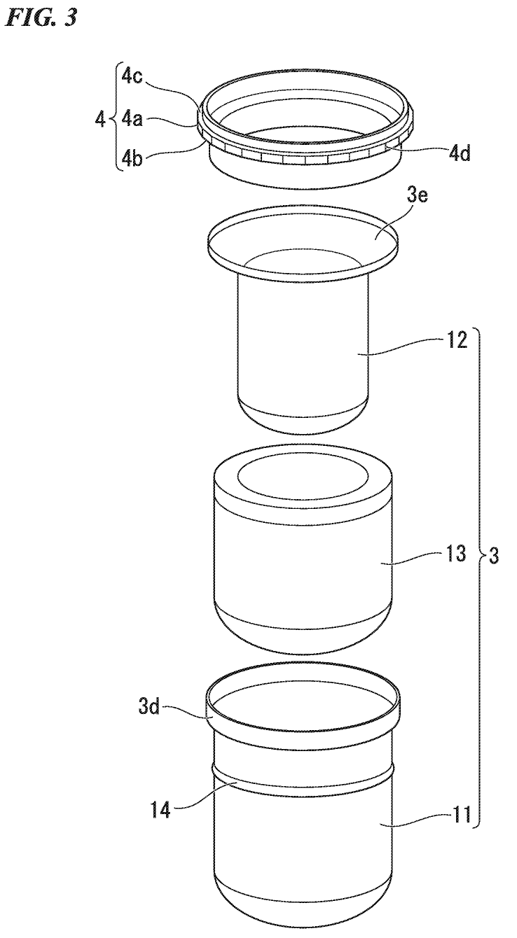

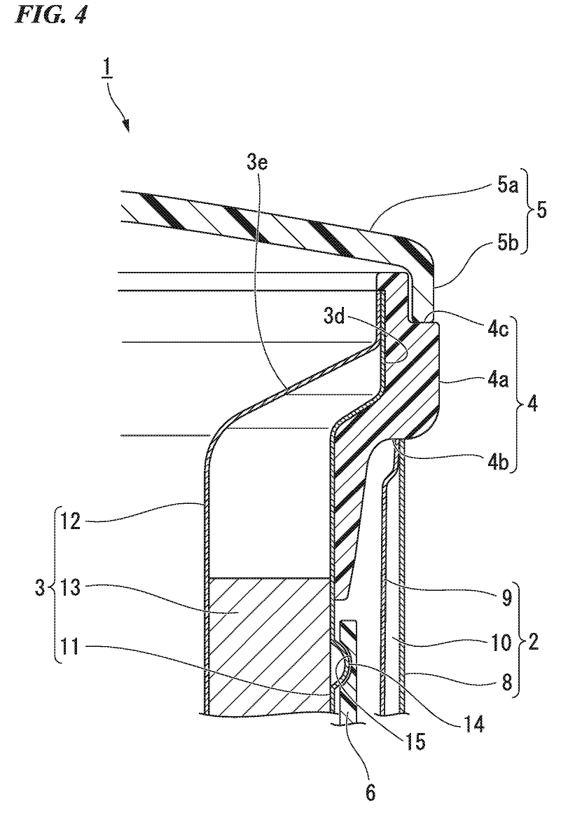

FIG. 1 is a perspective view that shows an embodiment of an ice cream maker. FIG. 2 is an exploded perspective view that shows the ice cream maker shown in FIG. 1. FIG. 3 is an exploded perspective view that shows the inside container shown in FIG. 2. FIG. 4 is a cross-sectional view that shows a main part of the cream maker shown in FIG. 1.

The ice cream maker 1 is a cold insulating container includes an outside container 2, an inside container 3, a ring member 4, a cap member 5, a cover member 6, and a spatula 7.

The outside container 2 is a heat insulating container having a vacuum heat insulating structure. Specifically, the outside container 2 is configured by a double walled container which includes a bottomed cylindrical outer container 8 and a bottomed cylindrical inner container 9 which are formed of stainless or the like, in which respective mouth portions are joined in a state in which the inner container 9 is stored in the outer container 8. In addition, a vacuum heat insulating layer 10 is provided between the outer container 8 and the inner container 9. For example, the vacuum heat insulating layer 10 can be formed by blocking a deaeration hole provided in a bottom surface central portion of the outer container 8 inside of a chamber, which is depressurized (vacuumed) to high vacuum. Coating, printing, or the like can be applied on the outer peripheral surface of the outside container 2.

The outside container 2 includes a bottom wall 2a having a circular shape in plan view, a peripheral wall 2b which is erect in a substantially cylindrical form from the outer periphery of the bottom wall 2a, and an upper opening portion 2c which is open in a substantially circular manner on the upper end of the peripheral wall 2b.

The inside container 3 is cold insulating container having a cold insulating structure. Specifically, the inside container 3 is configured by a double walled container which includes a bottom cylindrical outer container 11 and a bottom cylindrical inner container 12 which are formed of stainless or the like, in which respective mouth portions are joined in a state in which the inner container 12 is stored in the outer container 11. In addition, a cold insulating agent 13 is provided between the outer container 11 and the inner container 12. The cold insulating agent 13 is configured by filing raw liquid (or gel) cold insulating agent (also called as “refrigerant”) in a package formed of plastic, such as polyethylene. The raw liquid cold insulating agent 13 is prepared by adding a highly water absorptive polymer, antiseptic, stabilizer in water as a main component and adjusting the melting point to about −12° C.

The inside container 3 can be formed by directly pouring the raw liquid of the cold insulating agent 13 in the outer container 11, storing the inner container 12 in the outer container 11, and then joining respective mouth portions. In addition, the inside container 3 can also be formed by joining respective mouth portions in a state in which the inner container 12 is stored in the outer container 11, injecting the raw liquid of the cold insulating agent 13 from an injection hole formed at the bottom of the outer container 11, and sealing the injection hole. The outer container 11 and the inner container 12 which configure the inside container 3 are certainly integrated by using the same stainless steel and welding, caulking or the like.

The inside container 3 includes a bottom wall 3a having a circular shape in plan view, a peripheral wall 3b which is erect in a substantially cylindrical form from the outer periphery of the bottom wall 3a, and an upper opening portion 3c which is open in a substantially circular manner on the upper end of the peripheral wall 3b.

In addition, a neck portion 3d is provided at the upper end of the inside container 3 (outer container 11) so as to protrude outwardly throughout the entirety of the inside container 3 (outer container 11). A slope 3e having a decreased diameter in a depth direction is provided at the upper end of the inside container 3 (inner container 12) throughout the entirety of the inside container 3 (inner container 12). The diameter of the inside of the inside container 3 (inner container 12) is substantially equal from the lower end of the slope 3e to the bottom wall.

The ring member 4 is made of an elastic member having cold resistance such as rubber, elastomer, for example, silicone rubber. The ring member 4 is fitted to the neck portion 3d of the inside container 3 in a detachable manner. In the ice cream maker 1 of this embodiment, impact which is generated when the inside container 3 is stored in the outside container 2 can be absorbed by the ring member 4.

A flange 4a is provided at the outer periphery of the ring member 4 so as to protrude outwardly throughout the entirety of the ring member 4. In addition, a lower step portion 4b and an upper step portion 4c which have smaller diameter than that of the flange 4a are provided at both upper and lower sides of the flange 4a throughout the entirety of the flange 4a. In addition, a plurality of corner 4d which act as a slip stopper are provided on the outer periphery of the flange 4a along a circumferential direction.

The cap member 5 is a lid made of plastic having cold resistance, such as polypropylene. The cap member 5 includes a ceiling wall 5a having a circular shape in plan view, a peripheral wall 5b which is erect in a cylindrical form from the outer periphery of the ceiling wall 5a. In addition, a plurality of corner 5c which act as a slip stopper are provided on the outer periphery of the cap member 5 (peripheral wall 5b) along a circumferential direction.

The cover member 6 is a container made of plastic having cold resistance, such as polypropylene. The cover member 6 includes a bottom wall 6a having a circular shape in plan view, and a peripheral wall 6b which is erect in a substantially cylindrical form from the outer periphery of the bottom wall 6a, and an upper opening portion 6c which is open in a substantially circular manner on the upper end of the peripheral wall 6b. In addition, a pair of slits 6d which are cut from the upper end of the peripheral wall 6b in a depth direction is provided at the cover member 6. The pair of slits 6d is provided at the peripheral wall 6b in opposed positions. In addition, a hole (not shown in figures) is formed at the center of the bottom wall 6a. The cover member 6 is easily put in and taken out from the inside container 3 by the slits 6d, and the hole. The cover member 6 may include only the peripheral wall 6b having the upper opening portion 6c and lower opening portion without the bottom wall 6a.

In the ice cream maker 1 of this embodiment, it is possible to prevent frostbite and improve heat insulating ability by providing the cover member 6 made of plastic on the outside of the inside container 3 made of metal.

The cover member 6 is attached in the inside container 3 in a state of storing the inside container 3 in a detachable manner. Specifically, an engagement convex portion 14 having substantially semicircular shape in section view is provided on the outer peripheral surface of the inside container 3 (outer container 11) so as to protrude outwardly throughout the entirety thereof. An engagement recess portion 15 having a shape corresponding to the engagement convex portion 14 is provided on the inner peripheral surface of the cover member 6 (peripheral wall 6b) throughout the entirety of the cover member 6 (peripheral wall 6b). The cover member 6 is attached in a detachable manner to the inside container 3 by engaging the engagement convex portion 14 to the engagement recess portion 15.

In this embodiment, the engagement convex portion 14 is provided on the outer peripheral surface of the inside container 3, and the engagement recess portion 15 is provided on the inner peripheral surface of the cover member 6. However, the engagement recess portion 15 may be provided on the outer peripheral surface of the inside container 3, and the engagement convex portion 14 may be provided on the inner peripheral surface of the cover member 6.

The spatula 7 is a plate made of plastic having cold resistance, such as polypropylene. The spatula 7 has a length and a shape suitable for stirring the raw liquid of ice cream in the inside container 3.

As shown in FIG. 4, in ice cream maker 1 of this embodiment, the inside container 3 is stored in the outside container 2 in a state in which the upper end of the outside container 2 is in contact with the lower step 4b of the ring member 4. Accordingly, the inside container 3 is stored in the outside container 2 in a non-contact state through the ring member 4. In addition, the inside container 3 is stored in the outside container 2 in a non-contact state through the cover member 6. Furthermore, there is a sealed space between the outside container 2 and the inside container 3 by the ring member 4.

In addition, in the ice cream maker 1 of this embodiment, the upper opening portion 3c of the inside container 3 is closed with the cap member 5 in a state in which the lower end of the cap member 5 is in contact with the upper step 4c of the ring member 4. Accordingly, the upper opening portion 3c of the inside container 3 is closed with the cap member 5 in a non-contact state through the ring member 4. In addition, there is a sealed space between the inside container 3 and the cap member 5 through the ring member 4.

In the ice cream maker 1 having the structure explained above, the cold insulating state of the inside container 3 can be maintained for a long period of time by storing the inside container 3 which is cold to 0° C. or less in a freezer, for example, in the outer container 2. Ice cream can be easily produced by pouring the raw liquid of ice cream (content) in the inside container 3, and then stirring the raw liquid by the spatula 7.

In addition, in the ice cream maker 1 of this embodiment, since cold of the cold insulating agent 13 hardly escapes during making ice cream, the raw liquid of ice cream can be effectively cold.

Moreover, in the ice cream maker 1 of this embodiment, it is possible to store the inside container 3 in the outside container 2 in a state in which the cover member 6 is separately from the inside container 3. In addition, after using, the inside container 3 can be brought back to normal temperature within a relatively short time and with safety only by leaving the inside container 3 provided with the cover member 6 outside of the outside container 2.

As explained above, in the ice cream maker 1 of this embodiment, it is possible to store the inside container 3 in the outside container 2 with easily and safety by gripping the ring member 4 provided with the inside container 3 without direct contact with the cold inside container 3 when the inside container 3 is taken out from a freezer.

In addition, it is possible absorb the impact generated by storing the inside container 3 in the outside container 2 by the ring member 4.

Furthermore, since excessive space is not necessary for the ring member 4 when the inside container 3 is cold in a freezer, the ice cream maker 1 is easily used compared with a case in which the ice cream maker includes a grip.

In addition, the ring member 4 is made of elastic member, the flange 4a is the thickest portion, and a plurality of corner 4d which act as a slip stopper are provided on the outer peripheral surface of the flange 4a. Accordingly when the ring member 4 is held, the ring member 4 is easily held without feeling cold. The workability during stirring the raw liquid of ice cream with the spatula 7 can be improved.

In addition, in the ice cream maker 1 of this embodiment, since the inside container 3 is stored in the outside container 2 in a non-contact state through the ring member 4 and the cover member 6, heat transmittance between the outside container 2 and the inside container 3 can be prevented, and the cold insulating state of the inside container 3 can be maintained for a long period of time.

In addition, cold insulating effect to the inside container 3 can be improved by forming the space sealed by the ring member 4 between the outside container 2 and the inside container 3. Similarly, cold insulating effect to the inside container 3 can also be improved by forming the space sealed by the ring member 4 between the inside container 3 and the cap member 5.

Moreover, the present invention is not limited to the embodiment above, and various modifications, variations and alternatives should be possible within the scope of the present embodiment

For example, the heat insulating container of the present invention does not always include the cap member 5, the cover member 6, and the spatula 7, dissimilar to the ice cream maker 1 above. The cap member 5, the cover member 6, and/or the spatula 7 can be omitted.

In addition, the cap member 5 may have a cold insulating structure. When the cap member 5 has a cold insulating structure, and the upper opening portion 3c of the inside container 3 is closed with the cap member 5, the cold insulating effects of the inside container 3 can be further improved.

In addition, the ice cream maker 1 of the present invention is not limited to the ice cream maker having the appearance above, and the size, function, design, and so on, can be properly changed.

In addition, the heat insulating container of the present invention is not limited to the ice cream maker 1. The present invention is widely applied to a heat insulating container in which an inside container having a cold insulating structure or a heat insulating structure is stored in an outside container having a cold insulating structure or a heat insulating structure.

For example, the heat insulating container of the present invention is not limited to a heat insulating container including an outside container having a vacuum heat insulating structure. The heat insulating container of the present invention may include an outside container having a heat insulating structure using a heat insulating material such as an air layer or styrene foam, instead of the vacuum heat insulating layer 10.

In addition, the heat insulating container of the present invention is not limited to a heat insulating container including an inside container (cold insulating container) having cold insulating structure explained above. The heat insulating container of the present invention may include a heat insulating container including an inside container (heat-insulating container) having a heat insulating structure using a heat insulating agent, instead of the cold insulating agent 13.

When any heat insulating containers above is applied to the present invention, it is possible to heat insulating state (including cold insulating state) of the inside container stored in the outside container can be maintained for a long period of time, and facility of usage is further improved.

What is claimed is:

1. A heat insulating container, comprising:
an outside container having a heat insulating structure;
an inside container having a cold insulating structure or a heat insulating structure;
a ring member which is fitted to an outer periphery of an upper end of the inside container; and,
wherein the inside container is stored in the outside container in a non-contact state through the ring member.

2. The heat insulating container according to claim 1, wherein a lower step portion is formed on an outer periphery of the ring member, and the inside container is stored in the outside container in a state in which an upper end of the outside container is in contact with the lower step portion.

3. The heat insulating container according to claim 1, wherein the ring member is made of an elastic material, and the ring member is attached to the inside container in a detachable manner.

4. The heat insulating container according to claim 1, wherein the heat insulating container further comprises a cap member which closes an upper opening portion of the inside container, and the upper opening portion of the inside container is closed with the cap member in a non-contact manner through the ring member.

5. The heat insulating container according to claim 4, wherein the ring member comprises an upper step portion on an outer periphery thereof, and the upper opening portion of the inside container is closed with the cap member in a state in which a lower end of the cap member is in contact with the upper step portion.

6. The heat insulating container according to claim 1, wherein the heat insulating container further comprises a cover member which is attached to the inside container in a state in which the inside container is stored in the cover member.

7. The heat insulating container according to claim 6, wherein an engagement recess portion is formed on one of an outer periphery of the inside container or an inner periphery of the cover member, an engagement convex portion is formed on the other of an outer periphery of the inside container or an inner periphery of the cover member, and the cover member is attached to the inside container in a detachable manner by engaging the engagement recess portion and the engagement convex portion.

8. The heat insulating container according to claim 6, wherein a slit which is cut from an upper end of the cover member in a depth direction is formed in the cover member.

9. A heat insulating container, comprising:
an outside container having a heat insulating structure;
an inside container having a cold insulating structure or a heat insulating structure;
a cover member which is attached to the inside container in a state in which the inside container is stored in the cover member; and,
wherein the inside container is stored in the outside container in a non-contact state through the cover member.

10. The heat insulating container according to claim 9, wherein the heat insulating container further comprises a ring member on an outer periphery of an upper end of the inside container.

11. The heat insulating container according to claim 9, wherein the inside container is made of metal.
